(19) United States
(12) Patent Application Publication
(10) Pub. No.: US 2025/0199023 A1
(43) Pub. Date: Jun. 19, 2025

(54) INCORPORATING FUNCTIONAL UNITS INTO MODULES OF AUTOMATED DIAGNOSTIC ANALYSIS SYSTEMS TO INCREASE FUNCTIONALITY THEREOF

(71) Applicant: Siemens Healthcare Diagnostics Inc., Tarrytown, NY (US)

(72) Inventors: Rayal Prasad, Princeton, NJ (US); Yao-Jen Chang, Pinceton, NJ (US); Ankur Kapoor, Plainsboro, NJ (US); Benjamin S. Pollack, Jersey City, NJ (US)

(73) Assignee: Siemens Healthcare Diagnostics Inc., Tarrytown, NY (US)

(21) Appl. No.: 18/846,453

(22) PCT Filed: Mar. 21, 2023
(86) PCT No.: PCT/US2023/064745

§ 371 Date: Sep. 12, 2024

Related U.S. Application Data
(60) Provisional application No. 63/269,696, filed on Mar. 21, 2022.

(51) Int. Cl. G01N 35/00

(52) U.S. Cl. CPC G01N 35/0099; G01N 35/0092

(57) ABSTRACT

An automated diagnostic analysis system includes a plurality of modules for processing and analyzing biological samples, a sample transport system for transporting sample containers to and from each of the modules, and a system controller for workflow planning and execution of sample analyses. To increase functionality of the automated diagnostic analysis system without increasing the floor space of the system, one or more of the modules may be configured to receive one or more functional units each operative to perform an additional action in connection with the sample analyses. The functional unit does not require separate access to the sample transport system, and the system controller is configured to dynamically include the functional unit in the workflow planning and execution of the sample analyses. Methods of operating an automated diagnostic analysis system are also provided, as are other aspects.

### CROSS REFERENCE TO RELATED APPLICATION

This application claims the benefit of U.S. Provisional Patent Application No. 63/269, 696, entitled “INCORPORATING FUNCTIONAL UNITS INTO MODULES OF AUTOMATED DIAGNOSTIC ANALYSIS SYSTEMS TO INCREASE FUNCTIONALITY THEREOF” filed Mar. 21, 2022, the disclosure of which is hereby incorporated by reference in its entirety for all purposes.

### FIELD

This disclosure relates to automated diagnostic analysis systems and methods.

### BACKGROUND

In medical testing, automated diagnostic analysis systems may be used to analyze a biological sample to identify an analyte or other constituent in the sample. The biological sample may be, e.g., urine, whole blood, blood serum, blood plasma, interstitial liquid, cerebrospinal liquid, and the like. Such biological liquid samples are usually contained in sample containers (e.g., test tubes, vials, etc.) that may be transported in sample carriers via a sample transport system (comprising automated tracks) to and from various modules that perform various actions within the automated diagnostic analysis system. The various actions may include, e.g., sample container handling, sample pre-processing, sample analysis, and sample post-processing.

In some cases, the functionality of an existing automated diagnostic analysis system may need to increase because of, e.g., an epidemic or pandemic, new demands for additional types of analyses, or a general increase in workload.

Accordingly, improving the scalability of automated diagnostic analysis systems is desired.

### SUMMARY

In some embodiments, a module of an automated diagnostic analysis system is provided. The module includes the following: apparatus configured to perform an action on a sample container or on a liquid contained in the sample container, robotics configured to move the sample container to and from a sample transport system of the automated diagnostic analysis system, and one or more sensors. The module is configured to receive a functional unit therein, and the functional unit is configured to perform an additional action on a sample container or on a liquid contained in the sample container. The one or more sensors are configured to detect receipt of the functional unit in the module, and the robotics are further configured to transfer sample containers to and from the functional unit.

In some embodiments, a method of operating an automated diagnostic analysis system is provided. The method includes providing a module configured to receive a functional unit therein, wherein the module comprises the following: apparatus to perform an action on a sample container or on a liquid contained in the sample container, robotics configured to move the sample container to and from a sample transport system of the automated diagnostic analysis system, and one or more sensors. The method also includes receiving a functional unit in the module, wherein the functional unit is configured to perform an additional action on a sample container or on a liquid contained in the sample container. The method further includes detecting receipt of the functional unit in the module using the one or more sensors and communicating the receipt of the functional unit from the module to a system controller in response to the detecting.

Still other aspects, features, and advantages of this disclosure may be readily apparent from the following detailed description and illustration of a number of example embodiments and implementations, including the best mode contemplated for carrying out the invention. This disclosure may also be capable of other and different embodiments, and its several details may be modified in various respects, all without departing from the scope of the invention. For example, although the description below relates to automated diagnostic analysis systems, the incorporating of functional units into processing/analysis modules may be readily adapted to other complex systems. This disclosure is intended to cover all modifications, equivalents, and alternatives falling within the scope of the appended claims (see further below).

### BRIEF DESCRIPTION OF DRAWINGS

The drawings, described below, are for illustrative purposes and are not necessarily drawn to scale. Accordingly, the drawings and descriptions are to be regarded as illustrative in nature, and not as restrictive. The drawings are not intended to limit the scope of the invention in any way.

FIG. 1 illustrates a top schematic view of an automated diagnostic analysis system configured to perform one or more biological sample analyses according to embodiments provided herein.

FIG. 2 illustrates a side view of a sample container held in a sample carrier of the automated diagnostic analysis system of FIG. 1 according to embodiments provided herein.

FIG. 3 illustrates a top schematic view of an input/output module of the automated diagnostic analysis system of FIG. 1 according to embodiments provided herein.

FIG. 4 illustrates a top schematic view of a quality check module of the automated diagnostic analysis system of FIG. 1 according to embodiments provided herein.

FIGS. 5A and 5B illustrate top and side schematic views, respectively, of a module of the automated diagnostic analysis system of FIG. 1 configured to receive a functional unit according to embodiments provided herein.

FIG. 6 illustrates a top schematic view of a container tray drawer of an input/output module of the automated diagnostic analysis system of FIG. 1 configured to receive one or more functional units according to embodiments provided herein.

FIG. 7 illustrates a top schematic view of a functional unit of the automated diagnostic analysis system of FIG. 1 according to embodiments provided herein.

FIG. 8 illustrates a top schematic view of another functional unit of the automated diagnostic analysis system of FIG. 1 according to embodiments provided herein.

FIG. 9 illustrates a flowchart of a method of operating an automated diagnostic analysis system according to embodiments provided herein.

### DETAILED DESCRIPTION

Automated diagnostic analysis systems according to embodiments described herein may include a large number of sample carriers each carrying a sample container thereon. Each sample container may include a biological sample to be analyzed. The biological sample may be, e.g., urine, whole blood, blood serum, blood plasma, interstitial liquid, cerebrospinal liquid, and the like. Automated diagnostic analysis systems may also include a sample transport system for transporting the sample carriers throughout the system. Automated diagnostic analysis systems may further include a number of modules for performing sample container handling, sample pre-processing, sample analysis, and sample post-processing. Each of the modules is connected to the sample transport system for receiving and returning the sample containers. Automated diagnostic analysis systems may still further include a system controller in communication with the modules, the sample transport system, and the sample carriers. The system controller may plan the system's workflow. That is, the system controller may be operative to receive relevant information and then schedule and direct one or more analyses of samples in each of the sample containers to be performed at one or more of the modules. Such system controllers may be referred to as workflow planners. In some systems, the number of samples analyzed per day may number in the hundreds or even the thousands.

Over time, the types and numbers of analyses to be performed by an automated diagnostic analysis system may need to change. For example, during a pandemic, system functionality may need to increase (i.e., scale up) as demand increases for certain types and numbers of analyses. Some systems are known to support such functional scale ups by allowing additional modules to be added to the system along with a corresponding expansion of the sample transport system to service to those additional modules-provided sufficient floor space around the system is available to accommodate the additional modules and expanded sample transport system.

In those cases where sufficient floor space around an automated diagnostic analysis system is not available, or the amount of increased functionality needed is only incremental (such as, e.g., due to a modest or temporary increase in workload), which does not justify the addition of another module and expanded sample transport system, embodiments of the invention advantageously provide one or more functional units and modules configured to receive the functional units.

The functional units can advantageously increase the functionality of the system without expanding the sample transport system and without increasing the footprint of the automated diagnostic analysis system. The functional unit may be incorporated into an already-connected module of the system. The functional unit and the already-connected module may each be configured via suitable hardware and electrical connectors to allow for easy installation of the functional unit in the module. The functional unit may replace, e.g., lesser-used, redundant, or optional apparatus or storage space in the module. Functionality provided by the functional unit may include small-scale sample container handling, sample pre-processing, sample analysis, and/or sample post-processing.

Modules configured to receive a functional unit may have one or more sensors, such as an image capture device, operative to detect receipt of the functional unit and to identify the type of functionality provided by the functional unit. Identification of the type of functionality may be made by reading, e.g., a barcode or like identifier on the functional unit, by recognizing a particular component configuration of the functional unit via the one or more sensors, by electrical signaling between the functional unit and module upon connection, or by any other suitable technique. In some embodiments, a module may be configured to receive more than one functional unit.

Information regarding a received functional unit may be communicated from the module to the system controller, which is further operative to dynamically include the increased functionality provided by the functional unit in the workflow planning.

In other embodiments, receipt of a functional unit in a module and/or information regarding a received functional unit may be manually entered into a system controller by a user (e.g., a system operator).

Sample containers may be moved to and from the functional unit by a module's robotics (e.g., by one or more robotic arms), which are also configured to move sample containers within the module and to and from the sample transport system. Thus, the functional unit advantageously is independent of the sample transport system. That is, the functional unit does not require separate access to, or need to interface directly with, the sample transport system.

Examples of modules that may be more easily configured to receive one or more functional units are input/output modules and refrigeration/sample storage modules, which normally include sensors for detecting sample containers and robotics for handling the sample containers.

In some embodiments, the functional unit may be powered by a battery that is included in the functional unit. The battery may be rechargeable and, in some embodiments, may be recharged by the module. In other embodiments, the functional unit may be powered directly by the module upon being received in the module via electrical connectors/contacts. In some embodiments, power may be provided wirelessly to the functional unit from the module via electromagnetic induction.

A functional unit may, in some embodiments, be transported to a module by the sample transport system and may be installed automatically in the module by the module's robotics via the system controller. Additionally or alternatively, a functional unit may be manually installed in a module. Functional units may also be automatically and/or manually removed from host modules (i.e., the modules in which the functional units are received) in cases where, e.g., the additional functionality is no longer needed.

Advantageously, functional units can be easily installed and removed and accordingly provide easy hardware upgrades/changes, reduced serviceability costs, and flexible functional scalability of automated diagnostic analysis systems without the need for additional floor space and/or rearrangement or reconfiguration of existing modules and/or expansion and/or rearrangement or reconfiguration of the sample transport system of an automated diagnostic analysis system.

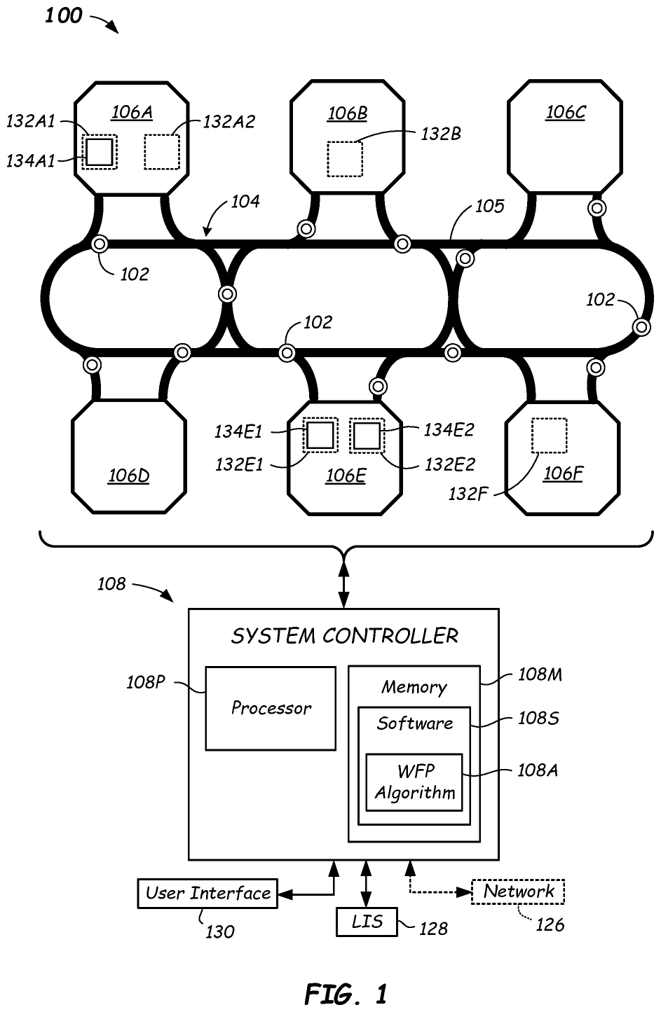

In accordance with one or more embodiments, automated diagnostic analysis systems having improved functional scalability will be explained in greater detail below in connection with FIGS. 1-9.

FIG. 1 illustrates an automated diagnostic analysis system 100 configured to automatically analyze biological samples according to one or more embodiments. Automated diagnostic analysis system 100 may include a plurality of sample carriers 102 (only three labeled in FIG. 1 to maintain clarity), a sample transport system 104 that includes an automated track 105, a plurality of modules 106A-F, and a system controller 108. Note that modules 106A-F, while illustrated as all having the same size and shape, are not limited to all having the same size and shape. Automated diagnostic analysis system 100 may include more or less modules and/or may include other components.

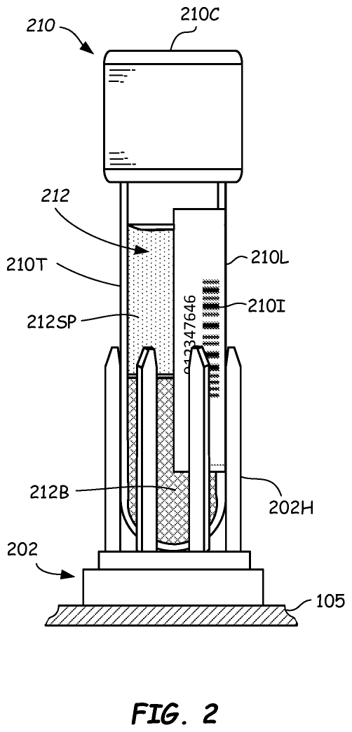

Each sample carrier 102 may be configured to carry one or more sample containers thereon. FIG. 2 illustrates a sample container 210 carried in a sample carrier 202, which is an embodiment of sample carrier 102. In some embodiments, sample carrier 202 may be a passive, non-motorized puck configured to carry a single sample container 210 on automated track 105 (e.g., via a magnet in sample carrier 202) of sample transport system 104. In other embodiments, sample carrier 202 may be an automated carrier including an onboard drive motor, such as a linear motor, that is programmed via system controller 108 to move about track 105 and stop at pre-programmed locations (e.g., one or more of modules 106A-F). Sample carrier 202 may include a holder 202H configured to hold sample container 210 in a defined upright position and orientation. Holder 202H may include a plurality of fingers or leaf springs that secure sample container 210 in and on sample carrier 202, wherein some fingers or leaf springs may be moveable or flexible to accommodate different sizes of sample containers. Other types and/or configurations of sample carrier 202 may be used.

Sample container 210 may include a cap 210C, a tubular body 210T, and a label 210L, which may include identification information 210I (e.g., indicia) thereon, such as a barcode, alphabetic characters, numeric characters, or combinations thereof. The identification information 210I may be machine readable at various locations within automated diagnostic analysis system 100. A biological sample 212 to be analyzed may be contained in sample container 210. The biological sample may be, e.g., urine, whole blood, blood serum, blood plasma, interstitial liquid, cerebrospinal liquid, or the like. In some embodiments, as shown in FIG. 2, biological liquid sample 212 may include a blood serum or plasma portion 212SP and a settled blood portion 212B.

Returning to FIG. 1, sample transport system 104 may be configured to transport sample containers to and from each of modules 106A-F via respective sample carriers 102 and track 105. Track 105 may include multiple interconnected sections configured to allow unidirectional or bidirectional sample container transport. Track 105 may be a railed track (e.g., a monorail or multi-rail), a collection of conveyor belts, conveyor chains, moveable platforms, or any other suitable type of conveyance mechanism. Track 105 may be circular, oval, or any other suitable shape or configuration and combinations thereof and, in some embodiments, may be a closed track.

Modules 106A-F may each be configured to perform one or more actions on a sample container or on a liquid contained in the sample container. In particular, one or more modules 106A-F may be configured to perform sample container handling, sample pre-processing, sample analysis, or sample post-processing.

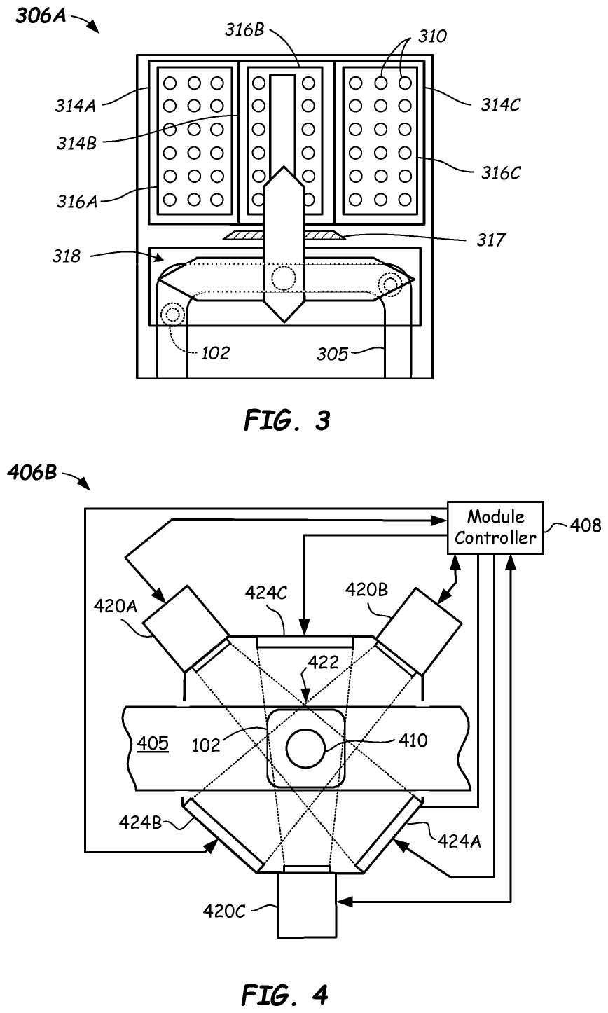

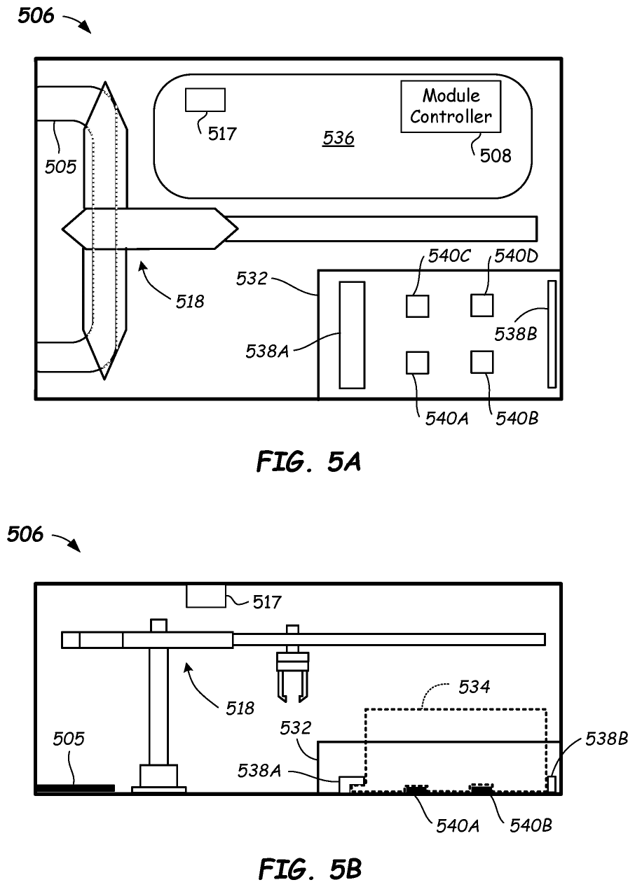

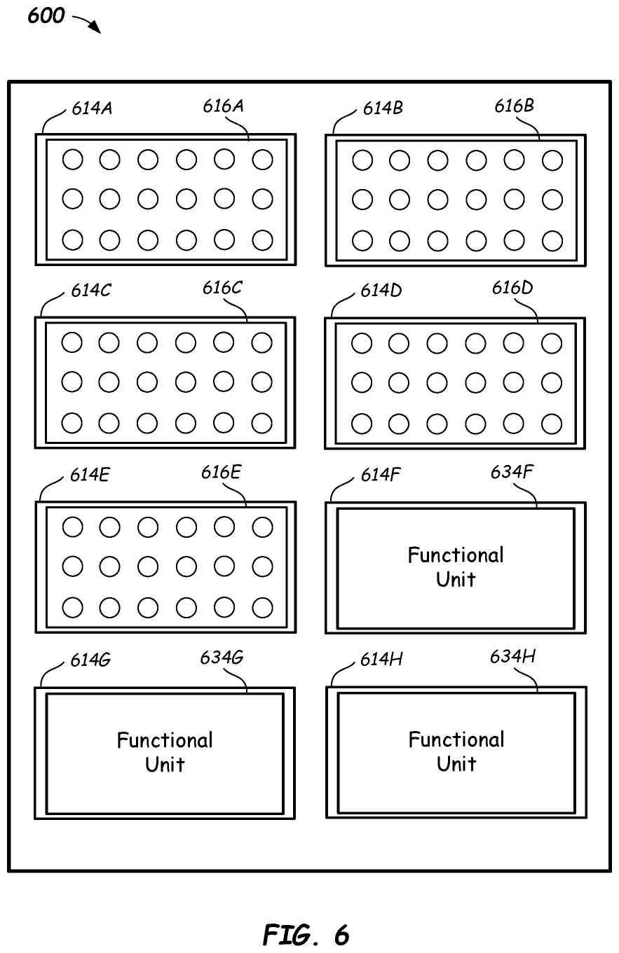

For example, module 106A may be an input/output module where sample containers may be received in and removed from automated diagnostic analysis system 100. FIG. 3 illustrates an example of an input/output module according to one or more embodiments. Input/output module 306A may include sample container storage compartments 314A-C each configured/sized to receive a rack or tray 316A-C of sample containers 310 (only two labeled). Sample containers 310 may each be identical or similar to, or different than, sample container 210. Input/output module 306A may also include a sensor 317 and robotics 318. Sensor 317 may be configured to detect sample containers 310 and to guide robotics 318 accordingly. Sensor 317 may be an image capture device (e.g., a camera). Robotics 318 may be configured to grasp and load each sample container 310 from trays 316A-C into a respective sample carrier 102 positioned on an internal track 305 extending through input/output module 306A and connecting to track 105. Once positioned on a sample carrier 102, the sample container 310 may be transported throughout system 100 to any module. Robotics 318 may also be configured to return sample containers 310 from sample carriers 102 to trays 316A-C for removal from system 100. Robotics 318 may include one or more robot arms and/or other components capable of at least two degrees of motion (e.g., X (lateral) and Z (vertical) directions), and preferably three degrees of motion (e.g., X, Y, and Z or radial and rotational motion). Robotics 318 may be a gantry robot, an articulated robot, an R-theta robot, or other suitable robot configured to pick up and place sample containers 310. In some embodiments, one or more of compartments 314A-C may be configured to receive a functional unit as described below in connection with FIGS. 5 and 6.

In another example, module 106B may be a quality check module where sample quality is checked before any sample processing occurs. FIG. 4 illustrates an example of a quality check module according to one or more embodiments. Quality check module 406B may be configured to perform, e.g., an HILN determination. An HILN determination identifies whether an interferent, such as hemolysis (H), icterus (I), and/or lipemia (L), which may adversely affect analysis results, is present in a sample to be analyzed, or whether the sample is normal (N) and can be further processed.

In some embodiments, quality check module 406B may include three image capture devices 420A-C approximately equally spaced apart from one another (e.g., about 120 degrees apart) around a system center location 422 for receiving a sample container 410 housed in a sample carrier 102 mounted on internal track 405, which connects to track 105. Sample container 410 may be identical or similar to, or different than, sample container 210. One or more of image capture devices 420A-C may be a camera. Other suitable types of image capture devices may be used. Operation of image capture devices 420A-C may be controlled by a module controller 408, which may also process images received from image capture devices 420A-C. Module controller 408 may include a processor, memory, and programming instructions, and may receive operating commands from system controller 108. Quality check module 406B may also include back panels 424A-C respectively positioned opposite image capture devices 420A-C with sample container 410 situated therebetween. Back panels 424A-C may provide a suitable background or backlighting. Image capture devices 420A-C may be used to capture images each from a different angle of sample container 410 and/or a biological sample contained in sample container 410. The images thereof may be analyzed by, e.g., an artificial intelligence algorithm executing in module controller 408 to perform an HILN determination. Samples determined to have an interferent present may be removed from system 100.

Returning again to FIG. 1, one or more of modules 106A-F may be, in addition to input/output or quality check modules, a pre-processing, analyzer, or post-processing module configured to perform one or more of, e.g., barcode reading; container imaging; container characterization (e.g., identifying the type and size of the sample container); sample characterization (e.g., identifying different liquid sample portions); fluid level determination; container decapping; sample temperature checking; sample centrifuging; pipetting actions (e.g., aspirating/dispensing and/or mixing of a sample with reagents, diluents, and/or other liquids); chemical analyses, immunoassay analyses, and/or hematological analyses (other types of analyses may alternatively or additionally be performed by modules 106A-F); container sealing/recapping; sample refrigeration; and/or sample storage.

System controller 108 may be in communication with each of sample carriers 102, sample transport system 104, and modules 106A-F either directly via wired and/or wireless connections or via a network 126. Network 126 may be, e.g., a local area network (LAN), wide area network (WAN), or other suitable communication network, including wired and wireless networks. System controller 108 may be housed as part of automated diagnostic analysis system 100 or may be remote therefrom.

System controller 108 may be in communication with one or more databases or like sources, represented in FIG. 1 as a laboratory information system (LIS) 128 for receiving sample information including, e.g., one or more of patient information, analyses to be performed on each sample, time and date each sample was obtained, medical facility information, tracking and routing information, and/or any other information relevant to the samples to be analyzed.

System controller 108 may be coupled to a user interface 130, which may include a display, to enable a user to access a variety of control and status display screens and to input commands and/or data into system controller 108.

System controller 108 may be configured to operate and/or control the various components of system 100, including sample carriers 102, sample transport system 104, and modules 106A-F. In particular, e.g., system controller 108 may control movement of each sample carrier 102 to and from any of modules 106A-F and to and from any other components (not shown) in system 100. System controller 108 may plan the workflow of system 100 based on information received from, e.g., LIS 128 and/or user interface 130. That is, the system controller may be operative to schedule and direct one or more analyses of each sample contained in a respective sample container 102 to be performed at one or more of modules 106A-F. System controller 108 may be considered a workflow planner.

System controller 108 may include a processor 108P, memory 108M, and programming instructions 108S (e.g., software, programs, algorithms, and the like). Programming instructions 108S may be stored in memory 108M and executable by processor 108P. A workflow planning (WFP) algorithm 108A also may be stored in memory 108M and executable by processor 108P. Memory 108M may further have one or more artificial intelligence (AI) algorithms stored therein to perform or facilitate various pre-and post-processing actions and/or sample analyses. System controller 108 may alternatively or additionally include other processing devices/circuits (including microprocessors, A/D converters, amplifiers, filters, etc.), transceivers, interfaces, device drivers, and/or other electronics.

Automated diagnostic analysis system 100 may further include one or more functional units received in modules 106A-F that are configured to receive the one or more functional units according to one or more embodiments. Functional units may each be configured to perform a limited or small-scale version of any of the actions and/or analyses performed by modules 106A-F.

As shown in FIG. 1, module 106A may have two designated areas 132A1 and 132A2 therein that are each configured to receive a respective functional unit, wherein a functional unit 134A1 is received in designated area 132A1. Module 106B may have one designated area 132B therein configured to receive a functional unit. Module 106E may have two designated areas 132E1 and 132E2 therein each configured to receive a respective functional unit, wherein a functional unit 134E1 is received in designated area 132E1 and a functional unit 134E2 is received in designated area 132E2. And module 106F may have one designated area 132F therein configured to receive a functional unit. Although only four modules are shown as being configured to receive either one or two functional units, other numbers of modules may be configured to receive functional units, and modules may be configured to receive other numbers of functional units (e.g., three or more).

Each designated area within a module may be a compartment, drawer, or other suitably sized space that may be available in the module and/or may serve a redundant or less-essential purpose in the module that can be replaced with a functional unit in response to an increased functionality demand. The designated area may be configured with suitable mechanical and/or electrical connectors/contacts such that a functional unit may be optionally received therein, be accessible to the module's robotics for moving sample containers to and from the functional unit as needed and be known to the module controller and/or the system controller in response to being received in the module.

FIGS. 5A and 5B illustrate a module 506 having a compartment 532 therein configured to receive a functional unit according to one or more embodiments. Compartment 532 may be originally or alternatively configured, e.g., to receive one or more sample containers (e.g., a tray or rack of sample containers). Module 506 may also include robotics 518, an internal track 505 that connects to track 105 (FIG. 1), and apparatus 536 for performing an action on a sample container or on a liquid contained in the sample container. The action may be any of the actions described above in connection with modules 106A-F, 306A, or 406B. Apparatus 536 may include a module controller 508 and one or more sensors 517 (only one shown). Sensor 517, which may be a camera, may be used to identify, e.g., sample containers, and/or to detect receipt of a functional unit in module 506. Sensor 517 may communicate the detection of a functional unit to module controller 508, which may then forward that communication to system controller 108 for inclusion in workflow planning. Alternatively, sensor 517 may instead directly communicate that detection to system controller 108. Other communication schemes are possible. Module 506 may include other sensors and/or components.

Compartment 532 may have mechanical connectors 538A and 538B spaced apart and configured to receive a functional unit 534 (shown in phantom in FIG. 5B) via, e.g., a frictional fit therebetween. Any suitable manner of receiving and securing a functional unit to a designated area of a module may be used, provided the original purpose of the designated area is operative upon removal of a functional unit from the designated area. In some embodiments, electrical connectors/contacts 540A-D may be provided in compartment 532 for connecting power and/or communications (e.g., control and/or data transfers) to a functional unit. The functional unit may have correspondingly positioned electrical connectors/contacts for mating with electrical connectors/contacts 540A-D. Note that more or less electrical connectors/contacts may be used. For example, in some embodiments where the functional unit is wirelessly connected to a network or the module and/or the system controller, only power connectors/contacts may be needed. In other embodiments where the functional unit may be, e.g., battery powered and wirelessly connected, the functional unit may have no corresponding electrical connectors/contacts. Other arrangements for powering and communicating with a functional unit received in a module of automated diagnostic analysis system 100 are possible.

In some embodiments, upon receipt and detection of functional unit 534 in compartment 532, module controller 508 may initiate an extra calibration step to properly align robotics 518 with the particular sample container location(s) of functional unit 534, which may be different than the previous sample container location(s) of compartment 532.

Another example of a module configured to receive one or more functional units is an input/output module (such as, e.g., input/output modules 106A and 306A). In some embodiments, an input/output module may have a container tray drawer with eight compartments (designated areas) for respectively receiving eight racks or trays of sample containers. Any one or more of the compartments may be configured to receive a functional unit, as shown in FIG. 6.

FIG. 6 illustrates a container tray drawer 600 of an input/output module (e.g., input/output module 106A) configured to receive one or more functional units according to one or more embodiments. Container tray drawer 600 may include a plurality of sample container storage compartments 614A-H each of which may be configured to receive a sample container tray, such as, e.g., sample container trays 616A-E, as shown. Each of compartments 614A-H may also be configured (either originally or retroactively) to alternatively receive a functional unit therein, such as, e.g., functional units 634F-H received in respective compartments 614F-H, as shown. In some embodiments, each of compartments 614A-H may have mechanical connectors (such as, e.g., mechanical connectors 538A and 538B) for securing a functional unit to container tray drawer 600. Functional units 634F-H may each perform a limited or small-scale version of any of the actions and/or analyses performed by modules 106A-F (FIG. 1). Depending on the present needs of an automated diagnostic analysis system (e.g., system 100), more or less functional units than those shown in FIG. 6 may be substituted for the sample container trays.

In some embodiments, a user may manually install a functional unit in one of compartments 614A-H of container tray drawer 600. Upon receipt therein, the functional unit may be automatically detected by one or more sensors of the input/output module or via connection with one or more electrical connectors/contacts (not shown) provided in compartments 614A-H (such as, e.g., electrical connectors/contacts 540A-D of FIGS. 5A and 5B). Such electrical connectors/contacts may be universal to a plurality of functional units providing different functions. The detection of a received functional unit may be communicated by the input/output module to the system controller for automatic inclusion of the functional unit in the workflow planning performed by the system controller.

In other embodiments, wherein the functional unit may perform a complex function, such as, e.g., a chemical analysis, a user may need to manually interface with the system controller via a user interface (e.g., user interface 130 of system controller 108) to integrate and/or activate the functional unit in the automated diagnostic analysis system. For example, a user may need to enter various information and data (e.g., in the form of a configuration file, etc.) that identifies the functional unit's capabilities (e.g., which chemical analyses can be performed) and provisions (e.g., which reagents or other chemicals or diluents) are included with the functional unit.

In still other embodiments, some functional units that perform complicated functions may require additional components and/or hardware to be available at one or more of the compartments 614A-H of container tray drawer 600. For example, if the functional unit provides refrigeration of samples or other materials used in the automated diagnostic analysis system, a supply line of coolant chemicals and corresponding connectors may need to be provided at a compartment of container tray drawer 600. Because of the specialized customization needed, only a limited number (e.g., one or two) of compartments 614A-H may be configured to receive such a functional unit. Such functional units may also require manual installation and manual integration and activation (via a system controller interface).

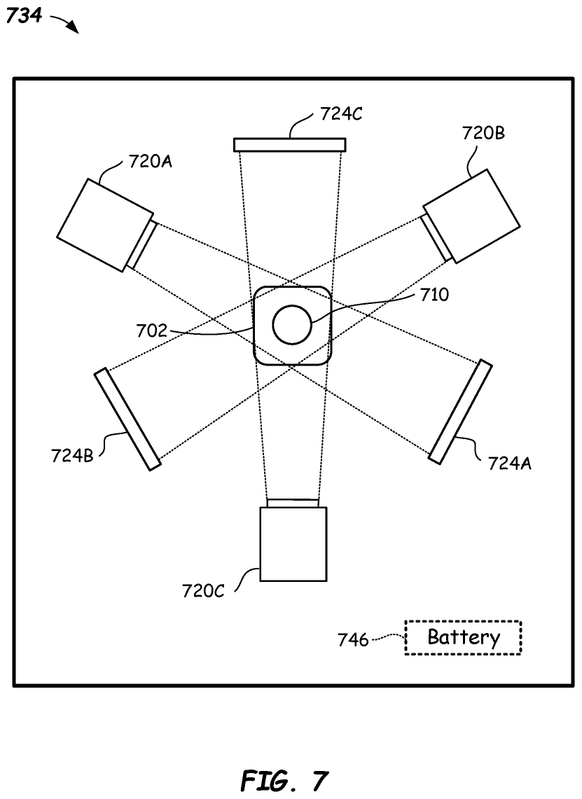

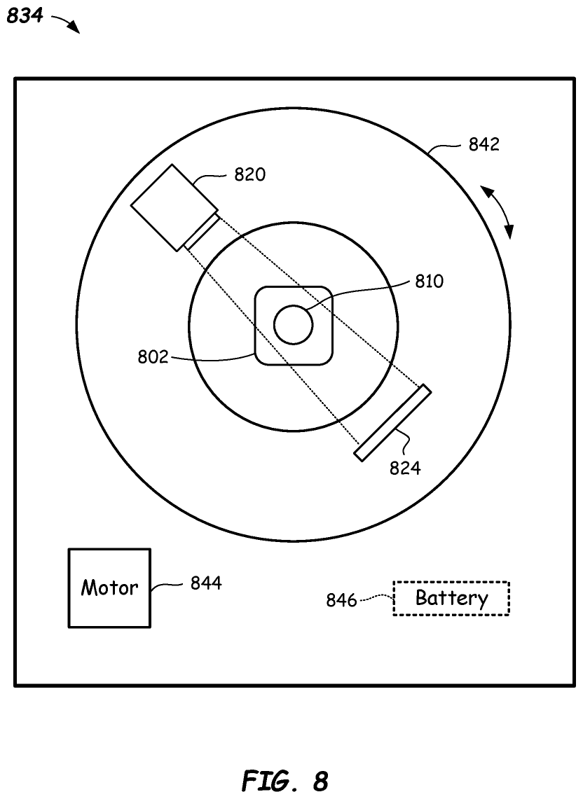

FIG. 7 illustrates an example of a functional unit according to one or more embodiments. Functional unit 734 may be configured to perform one or more optical processing functions including, e.g., barcode reading, container characterization (e.g., identifying the type and size of the sample container), sample characterization (e.g., identifying different liquid sample portions), fluid level determinations, sample quality checking (e.g., HILN determinations), and/or one or more other image-based analyses. Functional unit 734 may be functionally equivalent to quality check module 406B (FIG. 4).

Functional unit 734 may include three image capture devices 720A-C approximately equally spaced apart from one another (e.g., about 120 degrees apart) around a centered stationary sample carrier 702. Sample carrier 702 is configured to receive therein a sample container 710, which may be placed therein and removed therefrom by a host module's robotics (see, e.g., robotics 518 of FIGS. 5A and 5B). Advantageously, functional unit 734 is independent of sample transport system 104 (FIG. 1). Sample container 710 may be identical or similar to, or different than, sample container 210 (FIG. 2). Each of image capture devices 720A-C may be e.g., a camera; other suitable types of image capture devices may be used. Functional unit 734 may also include three back panels 724A-C respectively positioned opposite image capture devices 720A-C with sample container 710 situated therebetween. Back panels 724A-C may provide a suitable background or backlighting. Image capture devices 720A-C may each be used to capture an image from a different angle of sample container 710 and/or a biological sample contained in sample container 710. Operation of image capture devices 720A-C may be controlled by a host module controller or a system controller (e.g., system controller 108) via wireless communication or communication via electrical connectors/contacts (not shown in FIG. 7) such as, e.g., electrical connectors/contacts 540A-D of FIGS. 5A and 5B. A host module controller or a system controller may also process images received from image capture devices 720A-C. The captured images may then be used to perform one or more of the optical processing functions described above. In some embodiments, the images thereof may be analyzed by, e.g., an artificial intelligence algorithm executing in the host module controller or system controller.

Functional unit 734 may further include an optional battery 746 (or like power source) to provide power to functional unit 734 and, in some embodiments, may be rechargeable. In other embodiments, a rechargeable battery 746 may be recharged by the module in which it is received (i.e., the host module). Alternatively, functional unit 734 may be powered directly by the host module. Functional unit 734 may be easily factory-calibrated prior to installation in a module, and may be easily removed therefrom, which may advantageously eliminate the need for any on-site servicing.

FIG. 8 illustrates another example of a functional unit according to one or more embodiments. Functional unit 834 may also be configured to perform one or more optical processing functions including, e.g., barcode reading, container characterization (e.g., identifying the type and size of the sample container), sample characterization (e.g., identifying different liquid sample portions), fluid level determinations, sample quality checking (e.g., HILN determinations), and/or one or more other image-based analyses. Functional unit 834 may also be functionally equivalent to quality check module 406B (FIG. 4).

Functional unit 834 may include one image capture device 820 (e.g., a camera; other suitable types of image capture devices may be used), a back panel 824 to provide a suitable background or backlighting, a rotational platform 842, a platform motor 844, an optional battery 846 (or like power source), and a stationary sample carrier 802 positioned at a center location about which rotational platform 842 may rotate. Stationary sample carrier 802 is configured to receive therein a sample container 810, which may be placed therein and removed therefrom by a host module's robotics (see, e.g., robotics 518 of FIGS. 5A and 5B). Advantageously, functional unit 834 is independent of sample transport system 104 (FIG. 1). Sample container 810 may be identical or similar to, or different than, sample container 210. Platform motor 844 may be operative to rotate under the control of either a host module controller or a system controller via wireless communication or communication via electrical connectors/contacts (not shown in FIG. 8) such as, e.g., electrical connectors/contacts 540A-D of FIGS. 5A and 5B. Rotational platform 842 advantageously allows the one image capture device 820 to be used (instead of multiple image capture devices) to capture multiple images of sample container 810 from different angles as rotational platform 842 is capable of rotating 360 degrees. The captured images, which may be received and processed by the host module controller or the system controller, may then be used to perform one or more of the optical processing functions described above.

Optional battery 846 may provide power to functional unit 834 and, in some embodiments, may be rechargeable. In still other embodiments, a rechargeable battery 846 may be recharged by the host module. Alternatively, functional unit 834 may be powered directly by the host module. Functional unit 834 may be easily factory-calibrated prior to installation in a module, and may be easily removed therefrom, which may advantageously eliminate the need for any on-site servicing.

Other examples of a functional unit may include a small-scale sample container decapper or sealer, a small-scale centrifuge, a sample barcode labeler, and a sample temperature check module.

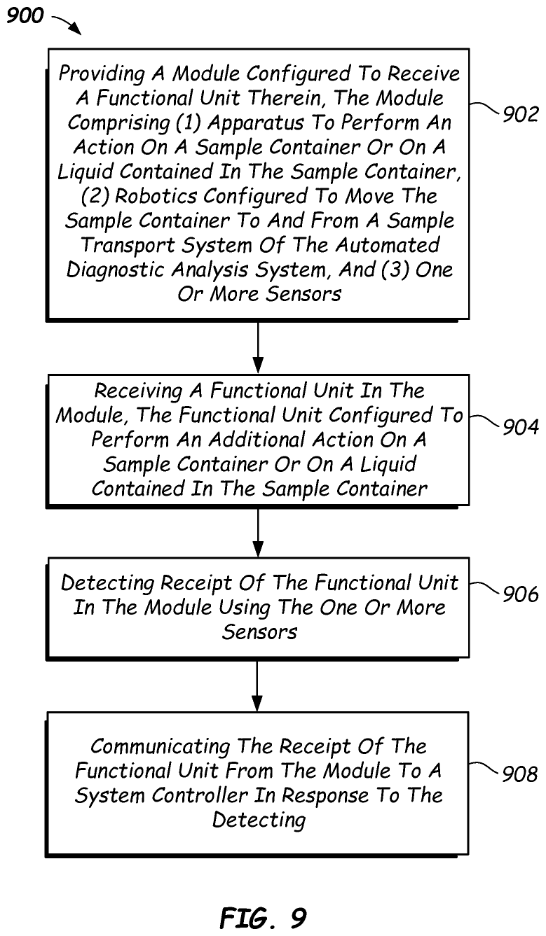

FIG. 9 illustrates a method 900 of operating an automated diagnostic analysis system according to one or more embodiments. At process block 902, method 900 may begin by providing a module configured to receive a functional unit therein, the module comprising the following: apparatus to perform an action on a sample container or on a liquid contained in the sample container, robotics configured to move the sample container to and from a sample transport system of the automated diagnostic analysis system, and one or more sensors. For example, the module may be any one of modules 106A, 106B, 106E, and 106F of FIG. 1; module 306A of FIG. 3; module 406B of FIG. 4; or module 506 of FIGS. 5A and 5B.

At process block 904, method 900 may include receiving a functional unit in the module, the functional unit configured to perform an additional action on a sample container or on a liquid contained in the sample container. For example, as shown in FIG. 1, functional unit 134A1 may be received in module 106A, and functional units 134E1 and 134E2 may be received in module 106E.

At process block 906, method 900 may include detecting receipt of the functional unit in the module using the one or more sensors. For example, as shown in FIGS. 5A and 5B, sensor 517 may be used to detect receipt of functional unit 534 in module 506.

At process block 908, method 900 may include communicating the receipt of the functional unit from the module to a system controller in response to the detecting. For example, upon detection of functional unit 534 by sensor 517, sensor 517 may communicate that detection to module controller 508, which may then forward that communication to system controller 108, or sensor 517 may directly communicate that detection to system controller 108.

In some embodiments, the receiving the functional unit in the module may include transporting the functional unit to the module via the sample transport system and installing the functional unit in the module via the module's robotics. For example, a compact functional unit may be transported to a host module via a carrier configured to carry the compact functional unit. The compact functional unit may include grasping features on, e.g., its top designed to be grasped, picked up, and placed in a module's designated area by a module's robotics.

In some embodiments, method 900 may also include one or more of the following: transferring a sample container to and from the functional unit using the module's robotics, configuring the functional unit with a battery to power the functional unit, and/or providing the functional unit with one image capture device mounted on a rotational platform for imaging a sample container to perform one or more optical processing functions.

While this disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure or the following claims.

What is claimed is:

1. A module of an automated diagnostic analysis system, comprising:
apparatus configured to perform an action on a sample container or on a liquid contained in the sample container;
robotics configured to move the sample container to and from a sample transport system of the automated diagnostic analysis system; and
one or more sensors; wherein:
the module is configured to receive a functional unit therein, the functional unit configured to perform an additional action on a sample container or on a liquid contained in the sample container;
the one or more sensors are configured to detect receipt of the functional unit in the module; and
the robotics are further configured to transfer sample containers to and from the functional unit.

2. The module of claim 1, further comprising the functional unit.

3. The module of claim 2, wherein the functional unit is battery powered or is configured to receive power from the module.

4. The module of claim 2, wherein the additional action performed by the functional unit includes one of container type identification, container decapping, container barcode reading, container sealing, sample centrifuging, sample temperature checking, sample quality checking, sample pre-processing, imaging, sample analysis, and sample post-sample processing.

5. The module of claim 2, wherein the functional unit comprises one camera mounted on a rotational platform for imaging a sample container and wherein the additional action performed by the functional unit includes optical quality checking.

6. The module of claim 1, further comprising a sample container storage compartment configured to receive the functional unit.

7. The module of claim 6, wherein the sample container storage compartment is configured to provide power wirelessly to the functional unit received therein via electromagnetic induction.

8. The module of claim 1, wherein the one or more sensors comprises an image capture device.

9. An automated diagnostic analysis system, comprising:
the module of claim 1;
a sample transport system configured to transport sample containers to and from the module via respective sample carriers and a track, each sample carrier configured to hold a sample container; and
a system controller in communication with the module and the sample transport system, the system controller comprising a processor and programming instructions executable thereon, the system controller operative to schedule and direct one or more of a first plurality of sample containers to be received via the sample transport system at the module and to schedule and direct a respective action to be performed by the module on each of the one or more of the first plurality of sample containers or on each respective liquid contained therein.

10. The system of claim 9, further comprising the functional unit received in the module, the functional unit configured to provide the additional action, wherein:
the one or more sensors detect receipt of the functional unit and detection thereof is communicated to the system controller; and
the system controller, in response to receiving communication of the detection, is further operative to schedule and direct one or more of a second plurality of sample containers to be received via the sample transport system at the module and to schedule and direct the additional action to be performed by the functional unit on each of the one or more of the second plurality of sample containers or on each respective liquid contained therein.

11. The system of claim 10, wherein the first plurality of sample containers and the second plurality of sample containers each include a same sub-plurality of sample containers scheduled and directed by the system controller to have both the action by the module and the additional action by the functional unit performed thereon or on a respective liquid contained therein.

12. A method of operating an automated diagnostic analysis system, the method comprising:
providing a module configured to receive a functional unit therein, the module comprising apparatus to perform an action on a sample container or on a liquid contained in the sample container, robotics configured to move the sample container to and from a sample transport system of the automated diagnostic analysis system, and one or more sensors;
receiving a functional unit in the module, the functional unit configured to perform an additional action on a sample container or on a liquid contained in the sample container;
detecting receipt of the functional unit in the module using the one or more sensors; and
communicating the receipt of the functional unit from the module to a system controller in response to the detecting.

13. The method of claim 12, wherein the system controller comprises a processor and programming instructions executable thereon, the method further comprising:
scheduling and directing, via the system controller, one or more of a first plurality of sample containers to be received at the module via the sample transport system; and
scheduling and directing, via the system controller, a respective action to be performed by the module on each of the one or more of the first plurality of sample containers or on each respective liquid contained therein.

14. The method of claim 13, further comprising:
scheduling and directing, via the system controller in response to the communicating, one or more of a second plurality of sample containers to be received at the module via the sample transport system; and
scheduling and directing, via the system controller, the additional action to be performed by the functional unit on each of the one or more of the second plurality of sample containers or on each respective liquid contained therein; wherein:
the first plurality of sample containers and the second plurality of sample containers each includes a same sub-plurality of sample containers.

15. The method of claim 12, further comprising transferring a sample container to and from the functional unit using the robotics.

16. The method of claim 12, further comprising configuring the functional unit with a battery to power the functional unit.

17. The method of claim 12, wherein the receiving comprises:
transporting the functional unit to the module via the sample transport system; and
installing the functional unit in the module via the robotics.

18. The method of claim 12, further comprising providing the module with a sample container storage compartment configured to receive the functional unit.

19. The method of claim 18, further comprising configuring the sample container storage compartment to provide power wirelessly to the functional unit via electromagnetic induction.

20. The method of claim 12, further comprising providing the functional unit with one image capture device mounted on a rotational platform for imaging a sample container and wherein the additional action performed by the functional unit includes optical quality checking.
